(19) United States
(12) Patent Application Publication
(10) Pub. No.: US 2021/0016883 A1
(43) Pub. Date: Jan. 21, 2021

(54) UNMANNED AERIAL VEHICLE AND LENS DESIGN METHOD

(71) Applicant: SZ DJI TECHNOLOGY CO., LTD., Shenzhen (CN)

(72) Inventors: Xiaoming WANG, Shenzhen (CN); Jiebin XIE, Shenzhen (CN); Wei REN, Shenzhen (CN)

(21) Appl. No.: 17/033,406

(22) Filed: Sep. 25, 2020

Related U.S. Application Data
(63) Continuation of application No. PCT/CN2018/081437, filed on Mar. 30, 2018.

(51) Int. Cl. B64C 39/02; G02B 3/04

(52) U.S. Cl. CPC B64C 39/024; B64C 2201/123; G02B 3/04

(57) ABSTRACT

An unmanned aerial vehicle (UAV) includes a body and a visual obstacle avoidance system. The visual obstacle avoidance system is mounted at the body and includes a binocular vision device and a light compensation device. The light compensation device is located between two cameras of the binocular vision device and includes a light source and a lens. The lens includes a convex surface facing the light source and a light-emitting surface opposite to the convex surface. The convex surface includes an aspheric surface or a freeform surface. The lens is configured to project a light beam emitted by the light source to form a light spot matching a field of view (FOV) of the binocular vision device.

### CROSS-REFERENCE TO RELATED APPLICATION

This application is a continuation of International Application No. PCT/CN2018/081437, filed Mar. 30, 2018, the entire content of which is incorporated herein by reference.

### TECHNICAL FIELD

The present disclosure generally relates to the unmanned aerial vehicle (UAV) technology field and, more particularly, to a UAV and a lens design method.

### BACKGROUND

In a photographing apparatus of the related technology, a light compensation device is usually configured to compensate light to adapt to different light conditions, which is beneficial for a vision module to collect image information. A light compensation lens of the light compensation device usually includes a total internal reflection (TIR) lens or a Fresnel lens. The TIR lens is mainly configured to collimate a light beam, but the light spot is too small, hence pixels provided within a field of view (FOV) of the vision module are too few and do not match the FOV of the vision module. The Fresnel lens needs a larger dimension and more half-wave zones when the FOV is relatively large, for example when the FOV is larger than 80°. However, the more the half-wave zones are, the more greatly the light attenuates, which is not good for improving the quality of the image captured in a low-illuminance environment.

### SUMMARY

Embodiments of the present disclosure provide an unmanned aerial vehicle (UAV) including a body and a visual obstacle avoidance system. The visual obstacle avoidance system is mounted at the body and includes a binocular vision device and a light compensation device. The light compensation device is located between two cameras of the binocular vision device and includes a light source and a lens. The lens includes a convex surface facing the light source and a light-emitting surface opposite to the convex surface. The convex surface includes an aspheric surface or a freeform surface. The lens is configured to project a light beam emitted by the light source to form a light spot matching a field of view (FOV) of the binocular vision device.

Embodiments of the present disclosure provide a method for designing a lens. The method includes determining a dimension of the lens, optimizing a surface shape of a convex surface of the lens to cause a focal length of the lens to reach a target focal length, and optimizing a field of view (FOV) and a standard deviation of brightness of the lens to cause the FOV and the standard deviation of the brightness to reach a target FOV and a target standard deviation of the brightness, respectively. The convex surface is a light entrance surface of the lens and includes an aspheric surface or a freeform surface. The lens further includes a light-emitting surface opposite to the convex surface.

### BRIEF DESCRIPTION OF THE DRAWINGS

FIG. 1 is a schematic perspective view of an unmanned aerial vehicle (UAV) according to some embodiments of the present disclosure.

FIG. 2 is a schematic block diagram of the UAV according to some embodiments of the present disclosure.

FIG. 3 is a schematic side view of a lens according to some embodiments of the present disclosure.

FIG. 4 is a schematic diagram showing a light spot formed by the lens according to some embodiments of the present disclosure.

FIG. 5 is a schematic diagram showing a plan view of the UAV according to some embodiments of the present disclosure.

FIG. 6 is a schematic diagram showing another plan view of the UAV according to some embodiments of the present disclosure.

FIG. 7 is a schematic diagram showing another plan view of the UAV according to some embodiments of the present disclosure.

FIG. 8 is a schematic diagram showing a plan view of the lens according to some embodiments of the present disclosure.

FIG. 9 is a schematic flowchart showing a lens design method according to some embodiments of the present disclosure.

FIG. 10 is another schematic flowchart showing the lens design method according to some embodiments of the present disclosure.

FIG. 11 is another schematic flowchart showing the lens design method according to some embodiments of the present disclosure.

FIG. 12 is another schematic flowchart showing the lens design method according to some embodiments of the present disclosure.

FIG. 13 is another schematic flowchart showing the lens design method according to some embodiments of the present disclosure.

FIG. 14 is another schematic flowchart showing the lens design method according to some embodiments of the present disclosure.

### REFERENCE NUMERALS

| | |
|---|---|
| 10 - UAV | 12 - Body |
| 14 - Visual obstacle avoidance system | 142 - Binocular vision module |
| 142A - Front binocular vision | 142B - Rear binocular vision |
| module | module |
| 142C - Lower binocular vision module | 1422 - Camera |
| 144 - Light compensation device | 1442 - Light source |
| 1444 - Lens | 14442 - Convex surface |
| 14444 - Light-emitting surface | 16 - Processor |

### DETAILED DESCRIPTION OF THE EMBODIMENTS

Embodiments of the present disclosure are described below. The examples of embodiments are shown in the accompanying drawings. Same or similar reference numerals represent same or similar components or components with same or similar functions. Embodiments described with reference to the accompanying drawings are exemplary and merely used to describe the present disclosure but should not be considered to limit the present disclosure.

The present disclosure provides many different embodiments or examples to implement different structures of the present disclosure. To simplify the present disclosure, components and settings of specific examples are described below. The description is merely exemplary and does not limit the present disclosure. The present disclosure uses repeated reference numerals and/or letters in different examples. The repeated reference numerals and/or letters are to simplify the description and make the description clear and does not indicate relationships between discussed embodiments and/or settings. The present disclosure provides examples of specific processes and materials. However, those of ordinary skill in the art may be aware of applications of other processes and/or uses of other materials.

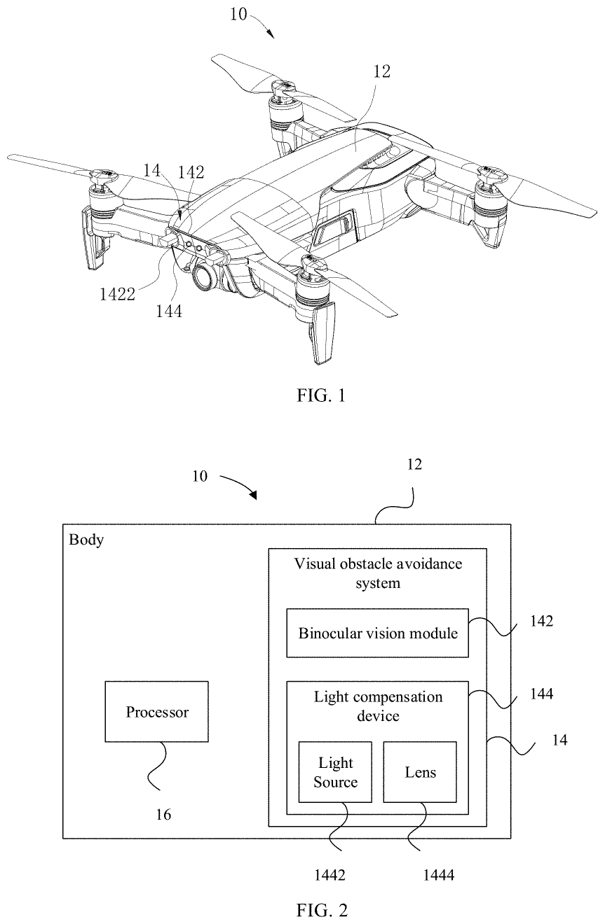

As shown in FIGS. 1-3, an unmanned aerial vehicle (UAV) 10 consistent with embodiments of the present disclosure includes a body 12, and a visual obstacle avoidance system 14. The visual obstacle avoidance system 14 is mounted at the body 12. The visual obstacle avoidance system 14 includes a binocular vision module (binocular vision device) 142 and a light compensation device 144. The light compensation device 144 is between two cameras 1422 of the binocular vision module 142. The light compensation device 144 includes a light source 1442 and a lens 1444. The lens 1444 includes a convex surface 14442 as a light entrance surface, and a light-emitting surface 14444 opposite to the convex surface 14442. The light-emitting surface is a plane surface. The convex surface 14442 can be an aspheric surface or a free-form surface. The light source 1442 is provided at the convex surface 14442 side. The lens 1444 is configured to project a light beam emitted by the light source 1442 to form a light spot matching a field of view (FOV) of the binocular vision module 142.

Based on the parallax principle, the binocular vision module 142 may capture a digital image of the same scene through two cameras 1422 mounted at fixed positions from two different angles to obtain a three-dimensional (3D) shape and position information of the scene. In combination with the light compensation device 144, the binocular vision module 142 may maintain good photographing and measurement performance in a low-illuminance environment. The binocular vision module 142 may be applied to the UAV 10 to implement smart obstacle avoidance, which is beneficial to improve the reliability of the UAV 10. In embodiments of FIG. 2, the visual obstacle avoidance system 14 may be connected to a processor 16 of the UAV 10. The processor 16 may be configured to control the flight of the UAV 10 according to a detection result of the visual obstacle avoidance system 14.

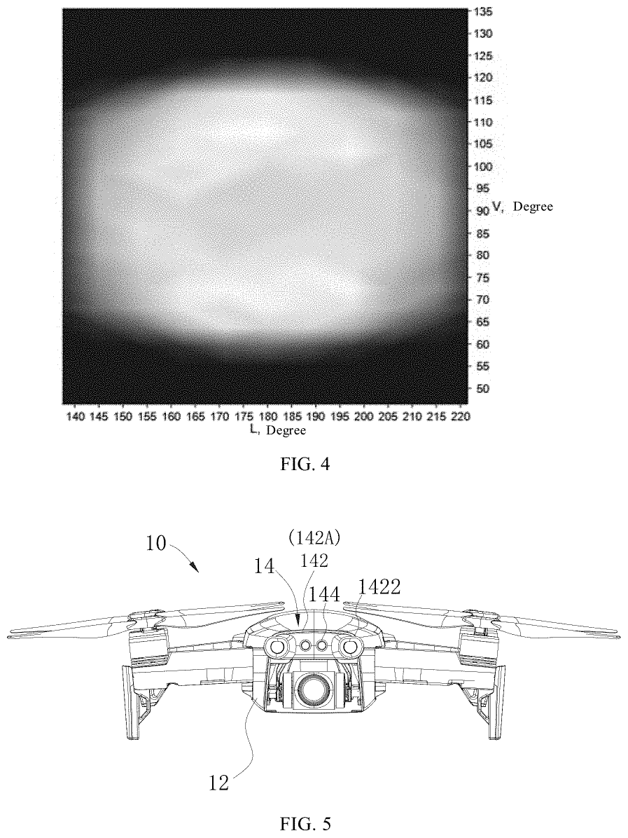

In the UAV 10 of embodiments of the present disclosure, a plane shape of a photosensitive element of the binocular vision module 142 may be a rectangular shape. The lens 1444 may be configured to project the light beam emitted by the light source 1442 on the side of the convex surface 14442 into a substantially rectangular uniform light spot. As such, the light spot can match the field of view (FOV) of the binocular vision module 142, which may be beneficial to improve the quality of the image captured by the binocular vision module 142 in the low-illuminance environment. As shown in FIG. 4, the light beam emitted from the lens 1444 can have substantially rectangular shape and uniform brightness.

As shown in FIG. 5, the light compensation device 144 is arranged at a line connecting the two cameras of the binocular vision module 142.

In some embodiments, two light compensation devices 144 may be included. Light spots formed by the two light compensation devices 144 may substantially overlap with each other in a range of distances longer than a preset distance to the body 12.

As such, the visual obstacle avoidance system 14 of the UAV 10 may use the light source 1442 with a relatively low power to cause an overlapped region of the light spots to reach a certain degree of illuminance, which may be beneficial to improve the measurement accuracy of the visual obstacle avoidance system 14 in the low-illuminance environment. The UAV 10 needs to maintain a certain safety distance to an obstacle during flight. When the obstacle exists in the safety distance, the UAV 10 may stop or change a direction to avoid the obstacle. The preset distance may be set according to the safety distance of the UAV 10.

In some embodiments, for example, the preset distance may be 0.5 m. That is, when the distance to the UAV 10 is longer than 0.5 m, the two light spots formed by the two light compensation devices may substantially overlap with each other. In other embodiments, the preset distance may be set flexibly according to actual needs.

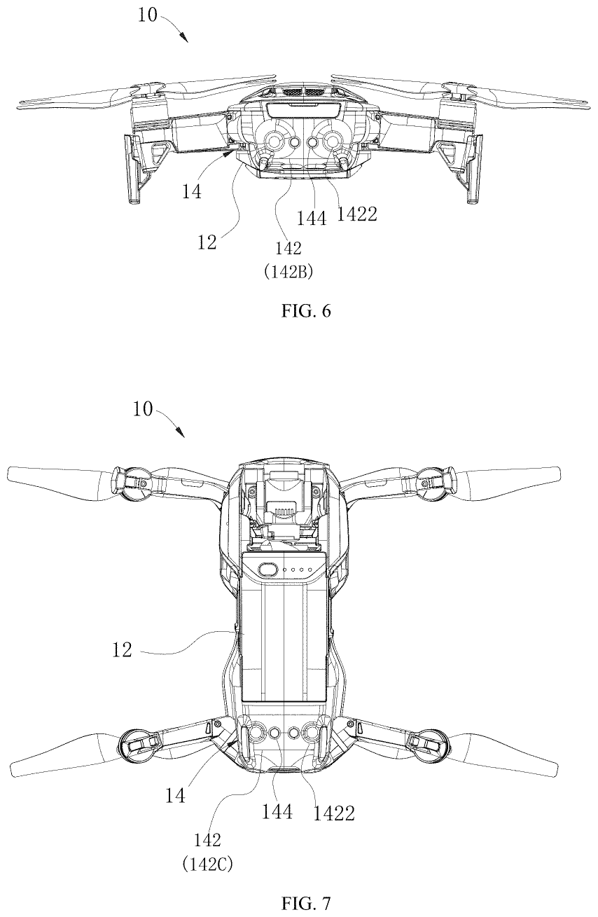

As shown in FIGS. 5-7, in some embodiments, the binocular vision module 142 includes at least one of a front binocular vision module 142A, a rear binocular vision module 142B, or a lower binocular vision module 142C.

The front binocular vision module 142A may be configured to obtain a 3D shape and position information of a scene in front of the UAV 10. The rear binocular vision module 142B may be configured to obtain a 3D shape and position information of a scene behind the UAV 10. The lower binocular vision module 142C may be configured to obtain a 3D shape and position information of a scene below of the UAV 10. As such, the visual obstacle avoidance system 14 may obtain the 3D shapes and position information of different scenes through the front binocular vision module 142A, the rear binocular vision module 142B, and the lower binocular vision module 142C to realize obstacle avoidance from different angles. The UAV 10 may implement more functions to improve user experience.

The binocular vision module 142 may include at least one of the front binocular vision module 142A, the rear binocular vision module 142B, or the lower binocular vision module 142C. That is, the binocular vision module 142 may include the front binocular vision module 142A, the rear binocular vision module 142B, or the lower binocular vision module 142C. The binocular vision module 142 may include the front binocular vision module 142A and the rear binocular vision module 142B, the front binocular vision module 142A and the lower binocular vision module 142C, or the rear binocular vision module 142B and the lower binocular vision module 142C. The binocular vision module 142 may include the front binocular vision module 142A, the rear binocular vision module 142B, and the lower binocular vision module 142C.

As shown in FIG. 8, in this example, the plane shape of the lens 1444 is a rectangular shape. A plane shape of the convex surface 14442 is a circular shape. In other embodiments, the plane shape of the lens 1444 may be another shape such as a circular shape, and the plane shape of the convex surface 14442 may be another shape such as an oval shape, which are not limited here.

In some embodiments, the lens 1444 may satisfy the following condition:

11 mm [symbol] f [symbol] 12 mm;

where f denotes a focal length of the lens 1444.

The lens 1444 may be applied to the light compensation device 144 of the binocular vision module 142. The light source 1442 may be arranged on the side of the convex surface 14442 of the lens 1444. When the focal length f satisfies the above condition, it is beneficial for the lens 1444 to project the light beam emitted by the light source 1442 into a space. The light spot formed by projection may satisfy a requirement of the FOV of the lens 1444. The focal length of the lens 1444 is short, which is beneficial to reduce the dimension of the light compensation device 144 in a light axis direction. Thus, a spatial setting of the light compensation device 144 may be optimized, which is beneficial for the miniature design of the light compensation device 144.

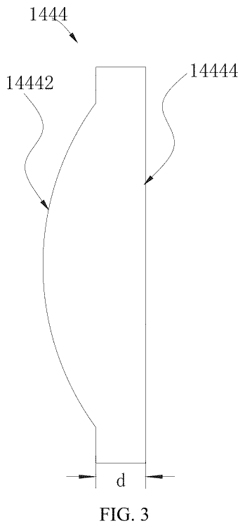

Referring to FIG. 3, in some embodiments, the lens 1444 satisfies the following condition:

2 mm [symbol] d [symbol] 3 mm;

where d denotes an edge thickness of the lens 1444.

As such, the edge thickness of the lens 1444 satisfies the above condition and may satisfy the focal length of the lens 1444. Similarly, when the edge thickness of the lens 1444 is relatively thin, the spatial setting of the light compensation device 144 may be optimized, which is beneficial for the miniature design of the light compensation device 144.

Referring to FIG. 3 and FIG. 8, in some embodiments, the convex surface 14442 adopts an aspheric design. An aspheric coefficient of the convex surface 14442 is determined by the following formula:

$$z = \frac{{ch}^{2}}{1 + \sqrt{1 - ( K + 1 ) {c}^{2} {h}^{2}}} + \sum {A}_{i} {h}^{i}$$

where, Z denotes a longitudinal distance from any point of the aspheric surface to a vertex of the surface, h denotes a distance from any point of the aspheric surface to the light axis, c denotes a vertex curvature (the inverse of the radius R of the curved surface at the vertex), K denotes a quadric constant, and Ai denotes an aspheric coefficient of a corresponding order.

In some embodiments, the convex surfaces 14442 may be an aspheric surface. The lens 1444 may satisfy the following conditions:

5 mm [symbol] Ry [symbol] 7 mm; and

−1 [symbol] Ky [symbol] −0.85;

where, Ry denotes a curvature radius of the aspheric surface in a y-direction, and Ky denotes a quadric coefficient of the aspheric surface in the y-direction.

As such, when the curved radius in the y-direction and a quadric curvature radius in the y-direction satisfies the above conditions, the focal length of the lens 1444 may be satisfied.

In some embodiments, the convex surface 14442 may be an aspheric surface. The lens 1444 may satisfy the following conditions:

15 mm [symbol] Rx [symbol] 16 mm; and

0.5 [symbol] Kx [symbol] 1;

where, Rx denotes a curved radius of the aspheric surface in an x-direction, and Kx denotes a quadric coefficient of the aspheric surface in the x-direction.

Similarly, when the curvature radius in the x-direction and the quadric curvature radius in the x-direction satisfies the above conditions, the focal length of the lens 1444 may be satisfied.

The curvature radius and the quadric curvature radius of the aspheric surface may affect the size of the focal length, and the curvature radius and the quadric coefficient in the y and x directions may satisfy the above conditions. Thus, the lens 1444 may satisfy the above focal length, which may be beneficial for the lens 1444 to project the light beam emitted by the light source 1442 into the space.

In some embodiments, the lens 1444 may satisfy the following conditions:

0.001 [symbol] A₄ [symbol] 0.002;

−0.0035 [symbol] A₆ [symbol] −0.003;

where A₄ denotes an aspheric coefficient a fourth-order aspheric coefficient of the aspheric surface, A₆ denotes a sixth-order aspheric coefficient of the aspheric surface, A₈ denotes an eighth-order aspheric coefficient of the aspheric surface, and A₁₀ denotes a tenth-order aspheric coefficient of the aspheric surface.

As such, choosing proper aspheric coefficients of the convex surface 14442 may further optimize the FOV of the lens 1444, which is beneficial for the lens 1444 to project the light beam into the space to form the light spot to match the FOV of the binocular vision module 142. Further, a standard deviation of illuminance of the light spot may also be optimized, so that the brightness of the light spot formed by the lens 1444 projecting the light beam into the space is uniform. As such, the quality of the image captured by the binocular vision module 142 may be improved.

In some embodiments, an applicable wavelength for the lens 1444 may include visible or and near-infrared light.

As such, the lens 1444 may be paired with the light source 1442 of a different wavelength. By maintaining a uniform light spot after projection, the quality of the image captured by the binocular vision module 142 may be improved. The wavelength of the light emitted by the light source 1442 may include the visible light and near-infrared light. A wavelength range of the visible light may be 380 nm to 780 nm. A wavelength range of the near-infrared light may be 780 nm to 2562 nm.

In some other embodiments, the lens 1444 may be paired with the wavelength of the corresponding light source 1442 or more wavelengths, which are not limited here.

In some embodiments, the material of the lens 1444 may include Poly(methyl methacrylate) (PMMA).

The PMMA has a good light-transmitting property, which is beneficial to project the light beam. The PMMA also has good mechanical strength and is easy to process, which is beneficial to improve the reliability of the lens 1444 and the light compensation device 144.

In some other embodiments, the material of the lens 1444 may further include glass, polyethylene terephthalate (PET), or another transparent material, etc.

In some embodiments, the light source 1442 may include a light-emitting diode (LED).

The LED has advantages, such as small volume, high efficiency, long lifetime, low cost, high on/off speed, etc. and may be used in the light compensation device 144, which is beneficial to lower production cost of the light compensation device 144.

In some other embodiments, the light source 1442 may include another light source 1442, which is not limited here.

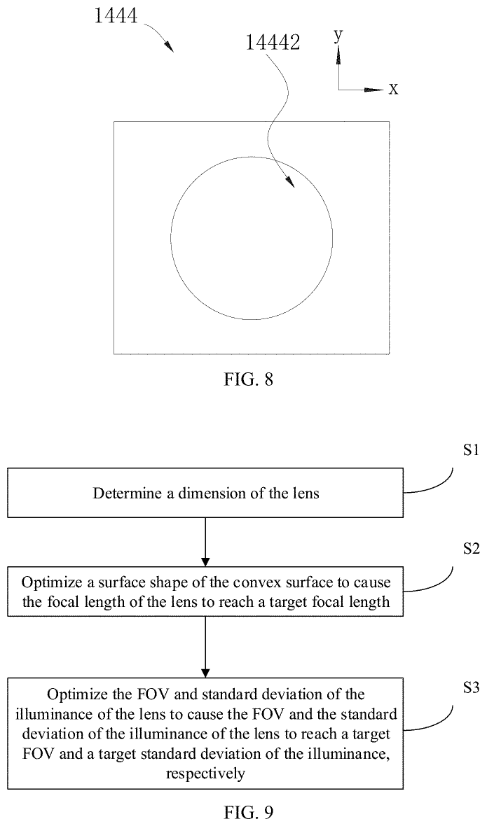

FIG. 9 shows a lens design method consistent with embodiments of the present disclosure. The lens 1444 includes the convex surface 1442 used as the light entrance surface, and the light-emitting surface 14444. The convex surface 14442 and the light-emitting surface 14444 are arranged on two sides of the lens 1444 opposite to each other, respectively. The convex surface 14442 includes an aspheric surface or freeform surface. The lens design method includes the following processes.

At S1, a dimension of the lens 1444 is determined.

At S2, a surface shape of the convex surface 14442 is optimized to cause the focal length of the lens 1444 to reach a target focal length.

At S3, the FOV and standard deviation of the illuminance of the lens 1444 are optimized to cause the FOV and the standard deviation of the illuminance of the lens 1444 to reach a target FOV and a target standard deviation of the illuminance, respectively.

In the lens design method of embodiments of the present disclosure, in process S1, a basic spatial dimension and parameter of the lens 1444 may be determined, such that the lens may project the light spot. In process S2, the focal length of the lens 1444 may meet the requirement by changing the surface shape of the convex surface 14442, which is beneficial to project the light beam to form the light spot. In process S3, the parameter of the convex surface 14442 may be changed to change the FOV and the standard deviation of the illuminance of the lens 1444, such that the FOV and the standard deviation of the illuminance of the lens 1444 may meet the requirements. That is, the lens 1444 may project the light beam to form the rectangular light spot, which matches the FOV of the binocular vision module 142. The uniform brightness of the light spot may improve the quality of the image captured by the binocular vision module 142.

In some embodiments, process S1 includes determining the material, the applicable wavelength, an aperture, and a thickness of the lens 1444 according to a spatial structure of the product, to which the lens 1444 is applied.

The spatial structure of the product that uses the lens 1444 may include a mounting position and spatial size for the lens 1444, a mounting position of the light source 1442, relative position of the light source 1442 with respect to the lens 1444, etc. Different materials of the lens 1444 may have different optical characteristics (e.g., Abbe number, refractive index, etc.). The needed size of the lens 1444 may be also different. The wavelength used can be determined by detecting the effect of the light beam projected by the lens 1444. The aperture and thickness can affect the space size of the lens 1444 itself. For example, when the lens 1444 is applied to the UAV 10, related characteristics of the lens 1444 may be set according to the spatial structure of the UAV 10.

In some embodiments, the convex surface 14442 may include an aspheric surface. In these embodiments, process S2 includes optimizing the curvature radius and the quadric coefficient of the aspheric surface to cause the focal length of the lens 1444 to reach the target focal length (S22).

As such, in process S22, the curvature radius and the quadric coefficient of the aspheric surface may affect the focal length. The curvature radius and the quadric coefficient of the aspheric surface may include the curvature radius and the quadric coefficient in the y-direction and the curvature radius and the quadric coefficient in the x-direction. By optimizing the curvature radiuses and the quadric coefficients in the y and x directions, the focal length of the lens 1444 may satisfy the requirements, which is beneficial for the lens 1444 to project the light beam emitted by the light source 1442 to the space.

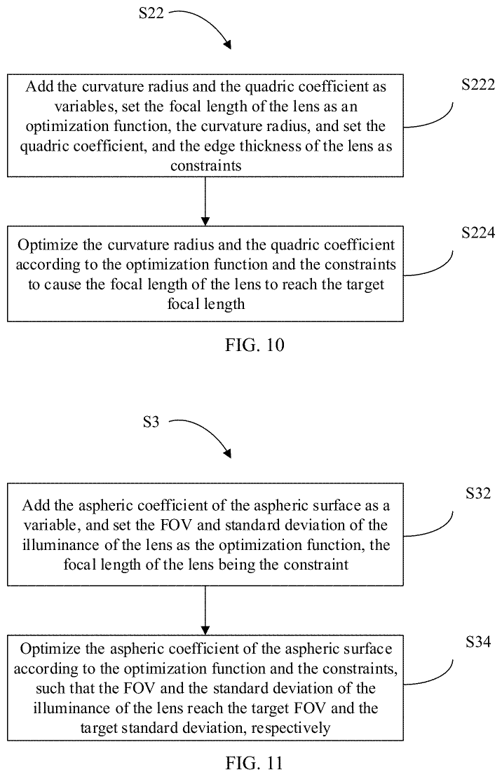

As shown in FIG. 10, in some embodiments, process S22 includes the following processes.

At S222, the curvature radius and the quadric coefficient are added as variables, the focal length of the lens 1444 is set as an optimization function, the curvature radius, the quadric coefficient, and the edge thickness of the lens 1444 are set as constraints.

At S224, the curvature radius and the quadric coefficient are optimized according to the optimization function and the constraints to cause the focal length of the lens 1444 to reach the target focal length.

A variable refers to a physical quantity to be optimized. An optimization function refers to a physical quantity that represents an optimization result to be achieved, and a certain target value may usually be set for the optimization function. A constraint condition refers to a physical quantity that needs to be constrained, and a certain value range or fixed value may be set for the constrained physical quantity, so that during the optimization process, the value of the constrained physical quantity may change within a certain range or not change. The optimization process may be a process of multiple iterations, that is, before the optimization function reaches the target value, the physical quantity may be continuously updated and optimized so that the optimization function may be continuously approaching the target value, until reaching the target value.

As such, in process S222, the curvature radius and the quadric coefficient may be added as the variables to be optimized. The focal length may be set as the optimization function, and the target focal length of the lens 1444 may be determined. The curvature radius, the quadric coefficient, and the edge thickness of the lens 1444 may be set as the constraints, such that the curvature radius, the quadric coefficient, and the edge thickness may change within a certain range or not change during the optimization process. In process 224, multiple iterations may be performed on the values of the curvature radius and the quadric coefficient, so that the focal length of the lens 1444 may be continuously approaching the target focal length, until reaching the target focal length.

In some embodiments, the target focal length of the lens 1444 may satisfy the following condition:

11 mm [symbol] F [symbol] 12 mm;

where F denotes the target focal length.

As such, the focal length of the lens 1444 may reach the target focal length F after the optimization. The target focal length F satisfying the above condition may be beneficial for the lens 1444 to project the light beam emitted by the light source 1442 to the space. The light spot formed by projection may satisfy the FOV requirement of the lens 1444. The small focal length of the lens 1444 may be beneficial to reduce the dimension of the lens 1444 of the light compensation device 144 in the light axis direction. As such, the spatial setting of the light compensation device 144 may be optimized, which may be beneficial for the miniature design of the light compensation device 144.

As shown in FIG. 11, in some embodiments, process S3 includes the following processes.

At S32, the aspheric coefficient of the aspheric surface is added as a variable, the FOV and standard deviation of the illuminance of the lens 1444 are set as the optimization function, and the focal length of the lens 1444 is the constraint.

At S34, the aspheric coefficient of the aspheric surface is optimized according to the optimization function and the constraints, such that the FOV and the standard deviation of the illuminance of the lens 1444 reach the target FOV and the target standard deviation, respectively.

The FOV and the standard deviation of the illuminance of the lens 1444 may be assigned with different weights. The weights may be set flexibly according to the actual needs.

After process S2, the optimization of the curvature radius and the quadric coefficient may be completed. The focal length of the lens 1444 may reach the target focal length. As such, in process S32, the aspheric coefficient of the aspheric surface is added as the variable to be optimized. The FOV and the standard deviation of the illuminance are set as the optimization function, and the target FOV and the target standard deviation of the lens 1444 are determined. The focal length of the lens 1444 is set as the constraint, such that the focal length of the lens 1444 may remain unchanged during the optimization. In process 34, when the aspheric coefficient is being optimized, multiple iterations may be performed according to different weights of the optimization function. As such, the FOV and the standard deviation of the illuminance of the lens 1444 may approach the target FOV and the target standard deviation, respectively. Finally, the FOV and the standard deviation of the illuminance of the lens 1444 may reach the target FOV and the target standard deviation, respectively. The FOV of the lens 1444 matches the FOV of the binocular module 142, and the brightness of the light spot formed by the lens 1444 projecting the light beam may be uniform.

The standard deviation of the illuminance of the lens 1444 may represent a degree of uniformity of the brightness of the light spot formed after the light beam passes through the lens 1444. When the standard deviation of the illuminance is smaller than or equal to the target standard deviation of the illuminance, the brightness of the light spot may be nearly uniform, which may be beneficial to improve the quality of the image captured by the binocular vision module 142.

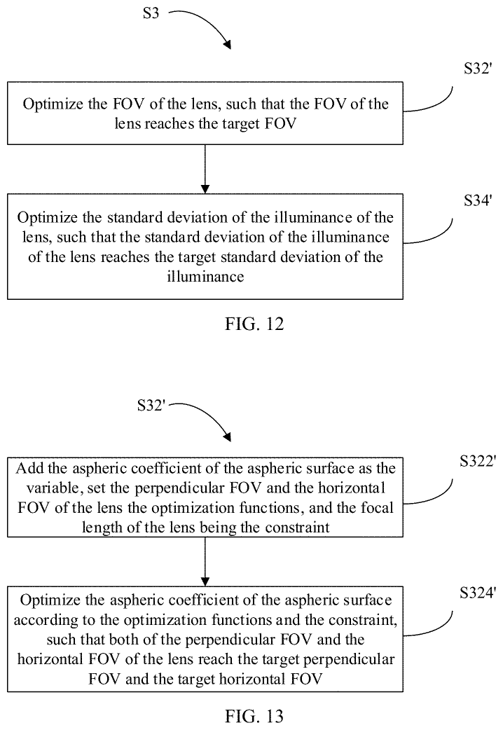

As shown in FIG. 12, in some embodiments, process S3 includes the following processes.

At S32′, the FOV of the lens 1444 is optimized, such that the FOV of the lens 1444 reaches the target FOV.

At S34′, the standard deviation of the illuminance of the lens 1444 is optimized, such that the standard deviation of the illuminance of the lens 1444 reaches the target standard deviation of the illuminance.

As such, the FOV and the standard deviation of the illuminance of the lens 1444 may be optimized separately. In some embodiments, process S32′ may be performed first, then process S34′ may be performed. In process S32′, the FOV may be performed first, such that the light spot formed by the lens 1444 projecting the light beam to the space may match the FOV of the binocular vision module 142. Then, in process S34′, the standard deviation of the illuminance of the lens 1444 may be optimized, such that the standard deviation of the illuminance of the lens 1444 may reach the target standard deviation of the illuminance. The brightness of the light spot formed by the lens 1444 projecting the light beam may be uniform. In some other embodiments, the order of process S32′ and process S34′ may be switched, that is, process S34′ may be performed first, and then process S32′ may be performed.

In some embodiments, the convex surface 14442 is aspheric. The FOV of the lens 1444 includes a perpendicular FOV and a horizontal FOV. In these embodiments, as shown in FIG. 13, process S32′ includes the following processes.

At S322′, the aspheric coefficient of the aspheric surface is added as the variable, the perpendicular FOV and the horizontal FOV of the lens 1444 are the optimization functions, and the focal length of the lens 1444 is the constraint.

At S324′, the aspheric coefficient of the aspheric surface is optimized according to the optimization functions and the constraint, such that both of the perpendicular FOV and the horizontal FOV of the lens 1444 reach the target perpendicular FOV and the target horizontal FOV.

As such, in process S322′, the aspheric coefficient of the aspheric surface is added as the variable to be optimized. The perpendicular FOV and the horizontal FOV of the lens 1444 are set as the optimization functions, and the target FOV of the lens 1444 may be determined and include the target perpendicular FOV and the target horizontal FOV. The focal length of the lens 1444 may be set as the constraint, such that the focal length of the lens 1444 may be maintained unchanged during the optimization process. In process S324′, multiple iterations are performed on the value of the aspheric coefficient of the aspheric surface, such that the perpendicular FOV and the horizontal FOV of the FOV of the lens 1444 may continuously approach the target perpendicular FOV and the target horizontal FOV. Finally, both of the perpendicular FOV and the horizontal FOV of the lens 1444 after the optimization may reach the target perpendicular FOV and the target horizontal FOV.

In some embodiments, the target perpendicular FOV and the target horizontal FOV correspond to the perpendicular FOV and the horizontal FOV of the binocular vision module 142, respectively. As such, the light spot formed by the lens 1444 projecting the light beam to the space may match the FOV of the binocular vision module 142.

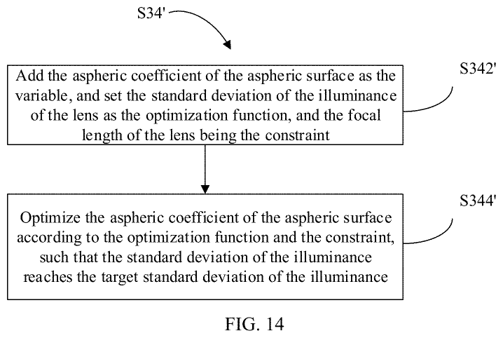

In some embodiments, the convex surface 14442 is aspheric. As shown in FIG. 14, process S34′ includes the following processes.

At S342′, the aspheric coefficient of the aspheric surface is added as the variable, the standard deviation of the illuminance of the lens 1444 is set as the optimization function, and the focal length of the lens 1444 is the constraint.

At S344′, the aspheric coefficient of the aspheric surface is optimized according to the optimization function and the constraint, such that the standard deviation of the illuminance reaches the target standard deviation of the illuminance.

As such, in process S342′, the aspheric coefficient of the aspheric surface is added as the variable to be optimized. The standard deviation of the illuminance of the lens 1444 is set as the optimization function. The target standard deviation of the illuminance of the lens 1444 is determined. The focal length of the lens 1444 is the constraint, such that the focal length may remain unchanged during the optimization. In process S344′, multiple iterations may be performed on the value of the aspheric coefficient of the aspheric surface, such that the standard deviation of the illuminance may continuously approach the target standard deviation of the illuminance. Finally, the optimized standard deviation of the illuminance may reach the target standard deviation of the illuminance.

In some embodiments, a plurality of aspheric coefficients may be included, and correspond to the aspheric coefficients of different orders of the aspheric surface. In process S3, the aspheric coefficients may gradually be added as the variables. The higher the order corresponding to the aspheric coefficient is, the more precise the optimization result is. When the optimization result does not satisfy the requirement after the aspheric coefficients corresponding to the lower orders are optimized, an aspheric coefficient corresponding to a next order may be added for optimization to cause the optimization function to reach the target value.

In embodiments of the present disclosure, reference terms of “certain embodiments,” “one embodiment,” “some embodiments,” “exemplary embodiments,” “examples,” “specific example,” or “some examples” mean to incorporate the specific features, structures, materials or characteristics described in embodiments or examples are included in at least one embodiment or example of the present disclosure. In the present disclosure, the schematic representations of the above-described terms do not necessarily refer to as same embodiments or examples. Further, the described specific features, structures, materials, or characteristics may be combined in an appropriate manner in any one or more embodiments or examples.

Any process or method description described in the flowchart or described in other ways herein can be understood as a module, segment, or part of code that includes one or more executable instructions for performing specific logical functions or steps of the process. The scope of embodiments of the present application includes other executions, which may not be in the order shown or discussed, including executing functions in a substantially simultaneous manner or reverse order according to the functions involved, which should be understood by those skilled in the art of the technical field, to which embodiments of the present disclosure belong.

The logic and/or processes represented in the flowchart or described in other ways herein, for example, can be considered as a sequenced list of executable instructions for executing logic functions, and can be executed in any computer-readable medium, for an instruction execution system, device, or equipment (such as, based on a computer-based system, a system including a processor, or other systems that can fetch instructions from the instruction execution system, device, or equipment and execute the instructions), or combine these instruction execution systems, devices, or equipment. For this specification, a “computer-readable medium” can be any device that can contain, store, communicate, propagate, or transmit a program for the instruction execution system, device, or equipment, or a device in combination with the instruction execution system, device, or equipment. Examples (non-exhaustive list) of the computer-readable medium include an electrical connector (electronic device) with one or more wiring, a portable computer disk case (magnetic device), a random access memory (RAM), a read-only memory (ROM), an erasable and editable read-only memory (EPROM or flash memory), a fiber optic device, and a portable compact disk read-only memory (CDROM). In addition, the computer-readable medium may even be paper or another suitable medium on which the program can be printed, because it can be used, for example, by optically scanning the paper or other medium, followed by editing, interpretation, or processed in other suitable manners to electronically obtain the program, and then stored in the computer memory.

Each part of the present disclosure may be executed by hardware, software, firmware, or a combination thereof. In the above-mentioned embodiments, multiple processes or methods may be executed by software or firmware stored in a memory and executed by a suitable instruction execution system. For example, if the processes or method are executed by hardware, as in other embodiments, the processes or method may be executed by any one or a combination of the following technologies known in the art: a discrete logic circuit of a logic gate circuit for performing logic functions on a data signal, an application-specific integrated circuit with a suitable combination of the logic gates, a programmable gate array (PGA), a field-programmable gate array (FPGA), etc.

Those of ordinary skill in the art should understand that all or a part of the processes carried in the above implementation method can be completed by a program instructing relevant hardware. The program can be stored in a computer-readable storage medium. When the program is executed, one of the processes of the method or a combination thereof may be realized.

In addition, various functional units in embodiments of the present disclosure may be integrated into one processing module, or each unit may physically exist alone, or two or more units may be integrated into one module. The above-mentioned integrated modules can be executed in the form of hardware or a software functional module. If the integrated module is executed in the form of the software functional module and sold or used as an independent product, the integrated module may also be stored in a computer-readable storage medium.

The storage medium may be a read-only memory, a magnetic disk, an optical disk, etc.

Although embodiments of the present application have been shown and described above, the above-mentioned embodiments are exemplary and should not be considered to limit the present disclosure. Those of ordinary skill in the art may change, modify, replace, and transform the above-described embodiments within the scope of the present disclosure.

What is claimed is:

1. An unmanned aerial vehicle (UAV) comprising:
a body; and
a visual obstacle avoidance system mounted at the body and including:
a binocular vision device; and
a light compensation device located between two cameras of the binocular vision device and including:
a light source; and
a lens including a convex surface facing the light source and a light-emitting surface opposite to the convex surface, the convex surface including an aspheric surface or a freeform surface, and the lens being configured to project a light beam emitted by the light source to form a light spot matching a field of view (FOV) of the binocular vision device.

2. The UAV of claim 1, wherein the light compensation device is one of two light compensation devices of visual obstacle avoidance system, and two light spots formed by the two light compensation devices overlap with each other in a range of distances longer than a preset distance to the body.

3. The UAV of claim 1, wherein the binocular vision device includes at least one of a front binocular vision device, a rear binocular vision device, or a lower binocular vision device.

4. The UAV of claim 1, wherein the lens satisfies following condition:
11 mm [symbol] f [symbol] 12 mm;
where f denotes a focal length of the lens.

5. The UAV of claim 1, wherein the lens satisfies following condition:
2 mm [symbol] d [symbol] 3 mm;
where d denotes an edge thickness of the lens.

6. The UAV of claim 1, wherein the convex surface includes an aspheric surface and the lens satisfies following conditions:
5 mm [symbol] Ry [symbol] 7 mm; and
−1 [symbol] Ky [symbol] −0.85;
where, Ry denotes a curvature radius of the aspheric surface in a y-direction, and Ky denotes a quadric coefficient of the aspheric surface in the y-direction.

7. The UAV of claim 1, wherein the convex surface includes an aspheric surface and the lens satisfies following conditions:
15 mm [symbol] Rx [symbol] 16 mm; and
0.5 [symbol] Kx [symbol] 1;
where, Rx denotes a curvature radius of the aspheric surface in an x-direction, and Kx denotes a quadric coefficient of the aspheric surface in the x-direction.

8. The UAV of claim 1, wherein an applicable wavelength of the lens includes at least one of wavelength of visible light or wavelength of near-infrared light.

9. The UAV of claim 1, wherein a material of the lens includes Poly(methyl methacrylate) (PMMA).

10. The UAV of claim 1, wherein the light source includes a light-emitting diode (LED)

11. A method for designing a lens comprising:
determining a dimension of the lens;
optimizing a surface shape of a convex surface of the lens to cause a focal length of the lens to reach a target focal length, the convex surface being a light entrance surface of the lens and including an aspheric surface or a freeform surface, and the lens further including a light-emitting surface opposite to the convex surface; and
optimizing a field of view (FOV) and a standard deviation of brightness of the lens to cause the FOV and the standard deviation of the brightness to reach a target FOV and a target standard deviation of the brightness, respectively.

12. The method of claim 11, wherein determining the dimension of the lens includes determining a material, an applicable wavelength, an aperture, and a thickness of the lens according to a spatial structure of a product that uses the lens.

13. The method of claim 11, wherein the convex surface includes the aspheric surface, and optimizing the surface shape of the convex surface to cause the focal length of the lens to reach the target focal length includes:
optimizing a curvature radius and a quadric coefficient of the aspheric surface to cause the focal length to reach a target focal length.

14. The method of claim 13, wherein optimizing the curvature radius and the quadric coefficient of the aspheric surface to cause the focal length of the lens to reach the target focal length includes:
adding the curvature radius and the quadric coefficient as variables, and setting the focal length as an optimization function, the curvature radius, the quadric coefficient, and the edge thickness of the lens being constraints; and
optimizing the curvature radius and the quadric coefficient to cause the focal length of the lens to reach the target focal length according to the optimization function and the constraints.

15. The method of claim 11, wherein the target focal length satisfies following condition:
11 mm [symbol] F [symbol] 12 mm;
where F denotes the target focal length.

16. The method of claim 11, wherein the convex surface includes the aspheric surface, and optimizing the FOV and the standard deviation of the brightness to cause the FOV and the standard deviation of the brightness to reach the target FOV and the target standard deviation of the brightness, respectively, includes:
adding an aspheric coefficient of the aspheric surface as a variable and setting the FOV and the standard deviation of the brightness as optimization functions, the focal length being a constraint; and
optimizing the aspheric coefficient of the aspheric surface according to the optimization functions and the constraint to cause the FOV and the standard deviation of the illuminance of the lens to reach the target FOV and the target standard deviation of the brightness, respectively.

17. The method of claim 11, wherein optimizing the FOV and the standard deviation of the brightness to cause the FOV and the standard deviation of the brightness to reach the target FOV and the target standard deviation of the brightness, respectively, includes:
optimizing the FOV to cause the FOV to reach the target FOV; and
optimizing the standard deviation of the brightness to cause the standard deviation of the brightness to reach the target standard deviation of the brightness.

18. The method of claim 17, wherein the convex surface includes the aspheric surface, the FOV includes a perpendicular a horizontal FOA, and optimizing the FOV to cause the FOV to reach the target FOV includes:
adding the aspheric coefficient of the aspheric surface as a variable and setting the perpendicular FOV and the horizontal FOV as optimization functions, the focal length being a constraint; and
optimizing the aspheric coefficient of the aspheric surface according to the optimization functions and the constraint to cause the perpendicular FOV and the horizontal FOV to reach a target perpendicular FOV and a target horizontal FOV, respectively.

19. The method of claim 17, wherein the convex surface includes the aspheric surface, and optimizing the standard deviation of the brightness to cause the standard deviation of the brightness to reach the target standard deviation of the brightness includes:
adding the aspheric coefficient of the aspheric surface as a variable and setting the standard deviation of the brightness as an optimization function, the focal length being a constraint; and
optimizing the aspheric coefficient of the aspheric surface according to the optimization function and the constraint to cause the standard deviation of the brightness to reach the target standard deviation of the brightness.
